(19) United States
(12) Patent Application Publication
(10) Pub. No.: US 2018/0192028 A1
(43) Pub. Date: Jul. 5, 2018

(54) 3D IMAGE ACQUISITION TERMINAL AND METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHUN-KAI PENG, New Taipei (TW); WEI WU, Shenzhen (CN); HAO-YUAN HUANG, New Taipei (TW); LEI HU, Shenzhen (CN); JIAN-GUO WU, Shenzhen (CN); CHIA-JUI HU, New Taipei (TW); YEN-YU CHEN, New Taipei (TW)

(21) Appl. No.: 15/811,834

(22) Filed: Nov. 14, 2017

(30) Foreign Application Priority Data
Dec. 30, 2016 (CN) 201611265266.4

(51) Int. Cl. H04N 13/02; H04N 5/33; G06T 7/70

(52) U.S. Cl. CPC H04N 13/0203; G06T 7/70; H04N 5/33

(57) ABSTRACT

A 3D image acquisition terminal includes an image capturing unit configured to capture an image of a target to obtain image information, and an infrared transceiver configured to scan the target to acquire distance information of the target. 3D image information of the target is generated according to the image information and the distance information.

### CROSS-REFERENCE TO RELATED APPLICATIONS

This application claims priority to Chinese Patent Application No. 201611265266.4 filed on Dec. 30, 2016, the contents of which are incorporated by reference herein.

### FIELD

The subject matter herein generally relates to 3D printing, and more particularly to an image acquisition terminal and method for acquiring a 3D image of an object.

### BACKGROUND

Generally, acquiring a 3D image of an object for printing requires a 3D scanner.

### BRIEF DESCRIPTION OF THE DRAWINGS

Implementations of the present disclosure will now be described, by way of example only, with reference to the attached figures.

FIG. 1 is a diagram of an exemplary embodiment of a connection relationship among an image acquisition terminal, a target, and a target device.

FIG. 2 is a diagram of the image acquisition terminal.

FIG. 3 is an isometric view of the image acquisition terminal.

FIG. 4 is a diagram of an image acquisition system of the image acquisition terminal.

FIG. 5 is a flowchart diagram of a method for acquiring a 3D image of a target.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

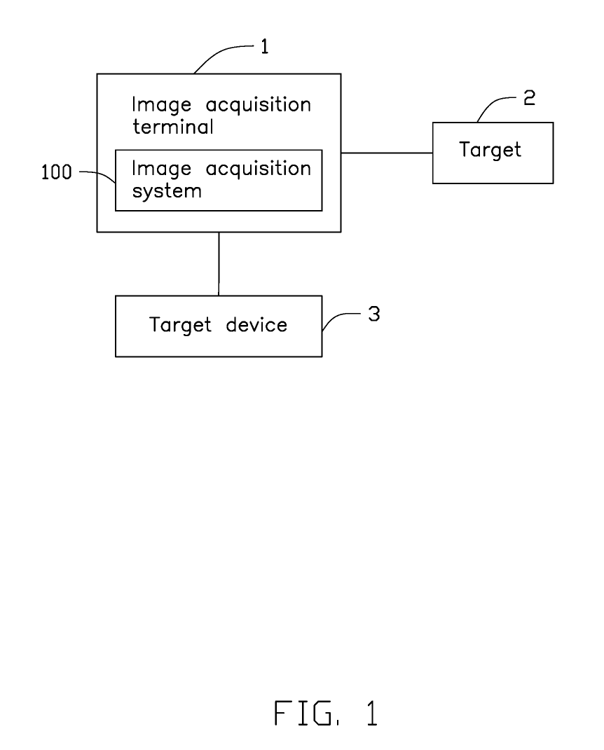

FIG. 1 illustrates an embodiment of an image acquisition terminal 1 including an image acquisition system 100. The image acquisition terminal 1 can scan a target 2, obtain 3D image information of the target 2, and send the 3D image information to a target device 3. In at least one embodiment, the image acquisition terminal 1 can be a mobile phone, a tablet computer, or the like. The target 2 can be a building, a car, or any physical object that can be printed by a 3D printer.

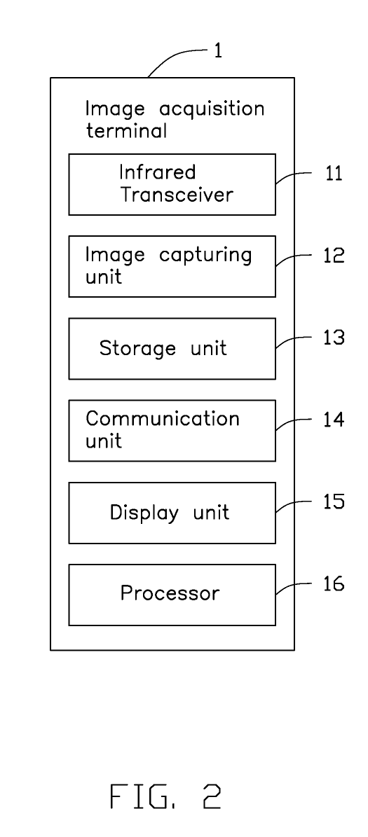

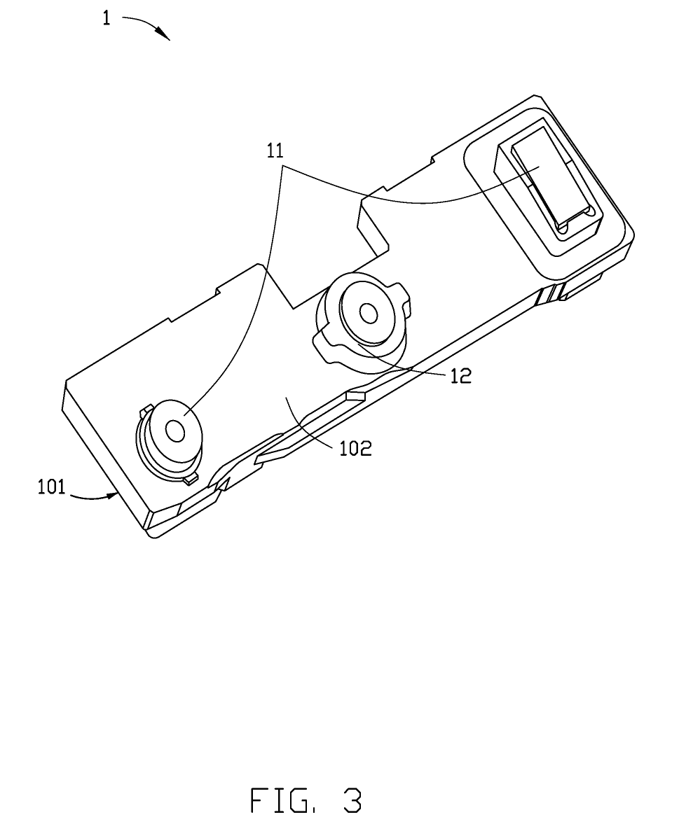

Referring to FIGS. 2 and 3, the image acquisition terminal 1 can include an infrared transceiver 11, an image capturing device 12, a storage unit 13, a communication unit 14, a display unit 15, and a processor 16. The image acquisition terminal 1 can include a front face 101 and a back face 102. The back face 102 can be opposite to the front face 101. The infrared transceiver 11 and the image capturing device 12 can be located on the back face 102. The display unit 15 can be located on the front face 101.

The infrared transceiver 11 can scan the target 2 to obtain distance information of the target 2. The infrared transceiver 11 can emit an infrared signal, and the infrared signal can be reflected by the target 2 back to the infrared transceiver 11. In at least one embodiment, a strength of an infrared signal emitted by the transceiver 11 decreases during a course of travel of the infrared signal. The infrared signal has a first energy value and a second energy value. The infrared signal has the first energy value when being emitted by the infrared transceiver 11 and has the second energy value when being received by the infrared transceiver 11. The first energy value is larger than the second energy value. The infrared transceiver 11 can calculate the distance information according to a difference between the first energy value and the second energy value.

The image capturing device 12 can capture an image of the target 2 to obtain image information of the target 2. In at least one embodiment, the image capturing device 12 is a camera. In another embodiment, the image capturing device 12 can be a 3D camera.

The display screen 15 can display the image captured by the image capturing device 12.

The communication unit 14 can establish communication between the image acquisition terminal 1 and the target device 3. For example, the communication unit 14 can be a data cable to establish a wired connection between the image acquisition terminal 1 and the target device 3. In another example, the communication unit 14 can be BLUETOOTH, WIFI, or an infrared transceiver to establish a wireless connection between the image acquisition terminal 1 and the target device 3.

The storage unit 13 can store the image acquisition system 100, and the image acquisition system 100 can be executed by the processor 16. In another embodiment, the image acquisition system 100 can be embedded in the processor 16. The image acquisition system 100 can be divided into a plurality of modules, which can include one or more software programs in the form of computerized codes stored in the storage unit 16. The computerized codes can include instructions executed by the processor 16 to provide functions for the modules. The storage unit 13 can be an external device, a smart media card, a secure digital card, or a flash card, for example. The processor 16 can be a central processing unit, a microprocessing unit, or other data processing chip.

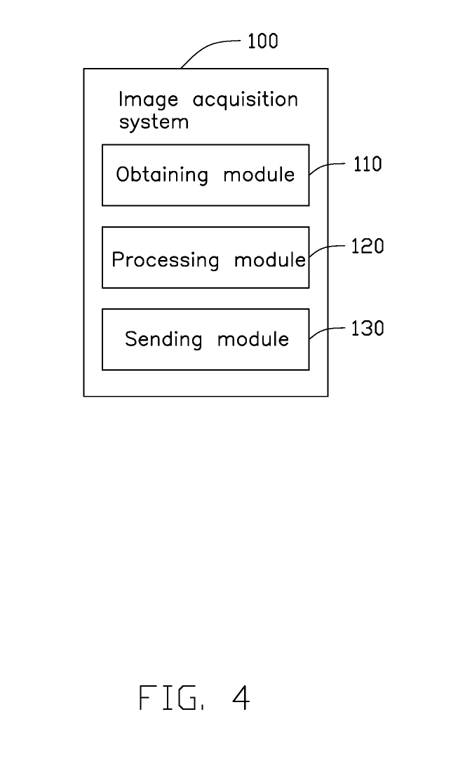

Referring to FIG. 4, the image acquisition system 100 can include an obtaining module 110, a processing module 120, and a sending module 130.

The obtaining module 110 can obtain the distance information and the image information from the infrared transceiver 11 and the image capturing device 12, respectively.

The processing module 120 can generate 3D image information according to the obtained distance information and image information.

The sending module 130 can send the 3D image information through the communication unit 14 to the target device 3. The target device 3 can be a computer, a server, a 3D printer, or the like.

In at least one embodiment, the processing unit 120 can convert the 3D image information into cross-sectional layers required by a 3D printer. In detail, the processing unit 120 obtains depth information from the 3D image information and generates a stereoscopic image from the depth information. The processing module 120 can generate a 3D model according to the stereoscopic image. The processor can convert the 3D model into the cross-sectional layers required by a 3D printer.

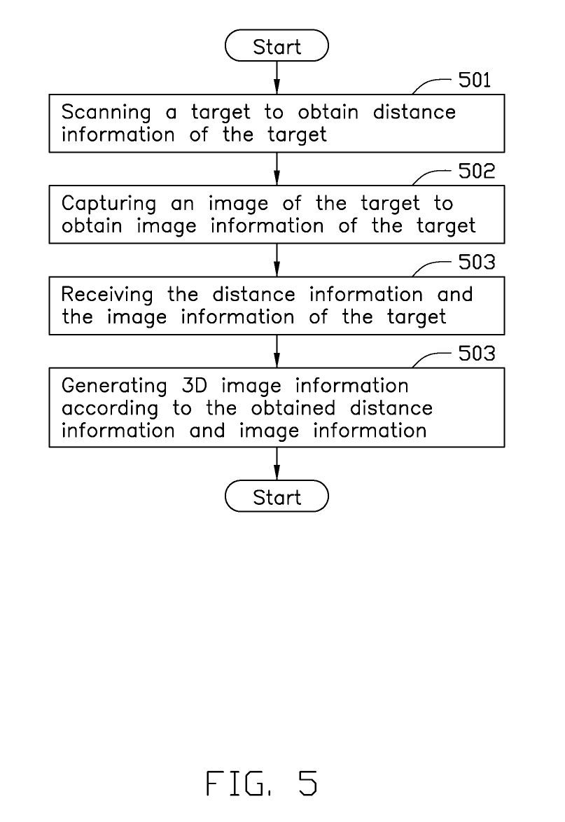

FIG. 5 illustrates a flowchart of an exemplary method for generating 3D image information. The example method is provided by way of example, as there are a variety of ways to carry out the method. The method described below can be carried out using the configurations illustrated in FIGS. 1-4, for example, and various elements of these figures are referenced in explaining the example method. Each block shown in FIG. 5 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure. The example method can begin at block S501

At block S501, an infrared transceiver can scan a target to obtain distance information of the target. The target can be a building, a car, or any physical object that can be 3D printed.

At block S502, an image capturing device can capture an image of the target to obtain image information of the target.

At block S503, the distance information and the image information can be received.

At block S504, the 3D image information can be generated according to the obtained distance information and image information.

The 3D image information can be sent to a target device. The target device can be a computer, a server, a 3D printer, or the like.

The 3D image information can be converted into cross-sectional layers required by a 3D printer to print. In detail, depth information from the 3D image information can be obtained, and a stereoscopic image can be generated from the depth information. A 3D model can be generated according to the stereoscopic image. The 3D model can be converted into the cross-sectional layers required by the 3D printer.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A 3D image acquisition terminal comprising:
an image capturing unit configured to capture an image of a target to obtain image information;
an infrared transceiver configured to scan the target to acquire distance information of the target;
a storage device; and
at least one processor, wherein the storage device stores one or more programs, when executed by the at least one processor, the one or more programs cause the at least one processor to:
obtain the image information and the distance information; and
generate 3D image information of the target according to the image information and the distance information.

2. The 3D image acquisition terminal of claim 1, wherein the processor is further configured to convert the 3D image information into cross-sectional layers required by a 3D printer to print the target.

3. The 3D image acquisition terminal of claim 1, wherein the processor is further configured to generate a stereoscopic image according to the 3D image information, generate a reconstructed 3D model from the stereoscopic image, and convert the reconstructed 3D model into cross-sectional layers required by a 3D printer to print the target.

4. The 3D image acquisition terminal of claim 3, wherein the processor obtains depth information from the 3D image information and generates the stereoscopic image according to the depth information.

5. The 3D image acquisition terminal of claim 1, further comprising a communication unit; wherein the processor is configured to send the 3D image information to a target device through the communication unit.

6. The 3D image acquisition terminal of claim 1, wherein the image acquisition terminal is a mobile phone or a tablet computer.

7. A method for acquiring a 3D image of a target comprising:
scanning the target to acquire distance information of the target;
capturing an image of the target to obtain image information;
obtaining the image information and the distance information; and
generating 3D image information of the target according to the image information and the distance information.

8. The method of claim 7, further comprising converting the 3D image information into cross-sectional layers required by a 3D printer to print the target.

9. The method of claim 7, further comprising:
generating a stereoscopic image according to the 3D image information;
generating a reconstructed 3D model from the stereoscopic image; and
converting the reconstructed 3D model into cross-sectional layers required by a 3D printer to print the target.

10. The method of claim 9, wherein the stereoscopic image is generated by:
obtaining depth information from the 3D image information; and
generating the stereoscopic image according to the depth information.

11. The method of claim 7, further comprising:
sending the 3D image information to a target device.

12. A non-transitory storage medium having stored thereon instructions that, when executed by a processor of a 3D image acquisition terminal, causes the processor to perform a method, wherein the method comprises:
controlling an infrared transmitter to scan a target to acquire distance information of the target;
control an image capturing device to capture an image of the target to obtain image information;
obtaining the image information and the distance information; and
generating 3D image information of the target according to the image information and the distance information.

13. The non-transitory storage medium of claim 12, wherein the processor is further configured to convert the 3D image information into cross-sectional layers required by a 3D printer to print the target.

14. The non-transitory storage medium of claim 12, wherein the processor is further configured to:
generate a stereoscopic image according to the 3D image information;
generate a reconstructed 3D model from the stereoscopic image; and
convert the reconstructed 3D model into cross-sectional layers required by a 3D printer to print the target.

15. The non-transitory storage medium of claim 14, wherein the stereoscopic image is generated by:
obtaining depth information from the 3D image information; and
generating the stereoscopic image according to the depth information.

16. The non-transitory storage medium of claim 12, wherein the processor is further configured to send the 3D image information to a target device.
